(19) United States
(12) Patent Application Publication
(10) Pub. No.: US 2019/0208124 A1
(43) Pub. Date: Jul. 4, 2019

(54) METHODS AND APPARATUS FOR OVERCAPTURE STORYTELLING

(71) Applicant: GoPro, Inc., San Mateo, CA (US)

(72) Inventors: David Newman, San Diego, CA (US); Ingrid Cotoros, San Mateo, CA (US)

(21) Appl. No.: 16/107,422

(22) Filed: Aug. 21, 2018

Related U.S. Application Data
(60) Provisional application No. 62/612,032, filed on Dec. 29, 2017.

(51) Int. Cl. H04N 5/232; G06T 7/194; G06K 9/00; G06K 9/32; G10L 17/00

(52) U.S. Cl. CPC H04N 5/23238; H04N 5/23296; G10L 17/005; G06K 9/00228; G06K 9/3233; G06T 7/194

(57) ABSTRACT

Apparatus and methods for overcapture storytelling. In one aspect, a method for the display of post-processed captured content is disclosed. In one embodiment, the method includes analyzing captured panoramic video content for portions that satisfy a cinematic criteria; presenting options to a user of available cinematic styles pursuant to the satisfied cinematic criteria; receiving a selection in accordance with the presented options; post-processing the captured panoramic video content in accordance with the received selection; and causing display of the post-processed captured panoramic video content. In some implementations, the analysis of captured panoramic video content is performed via the use of metadata associated with the captured panoramic video content. Image capture devices, computing systems, computer-readable apparatus and integrated circuit apparatus are also disclosed.

### PRIORITY

This application claims the benefit of priority to U.S. Provisional Patent Application Ser. No. 62/612,032 filed Dec. 29, 2017 of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the disclosure

The present disclosure relates generally to storing, processing and/or presenting of image data and/or video content, and more particularly in one exemplary aspect to providing overcapture storytelling of captured content.

### Description of Related Art

Commodity camera technologies are generally fabricated to optimize image capture from a single vantage point. Single vantage capture is poorly suited for virtual reality (VR), augmented reality (AR) and/or other panoramic uses, which require much wider fields of view (FOV); thus, many existing applications for wide FOV use multiple cameras to capture different vantage points of the same scene. The source images from these different vantage point cameras are then stitched together (e.g., in post-processing) to create the final panoramic image or other wide field of view content. However, wider FOV content can be incredibly tedious to edit, due in large part to the volume of data captured (as compared with single vantage point capture) and the near limitless number of angles that may conceivably be selected and rendered. Additionally, the average user of a wider FOV (e.g., 360°) image capture device often times does not have the cinematographic training in order to know when their capture is “interesting” nor can they recreate the cinematographic “language”.

To these ends, solutions are needed to facilitate the rendering process for wider FOV (e.g., overcapture) content. Ideally, such solutions would enable users too seamlessly and more rapidly post-process this captured wider FOV content in order to produce an interesting “story”. Additionally, such solutions should encourage a user's use of wider FOV image capture devices.

### SUMMARY

The present disclosure satisfies the foregoing needs by providing, inter alia, methods and apparatus for overcapture storytelling.

In one aspect, a method for the display of post-processed captured content is disclosed. In one embodiment, the method includes analyzing captured panoramic video content for portions that satisfy a cinematic criteria; presenting options to a user of available cinematic styles pursuant to the satisfied cinematic criteria; receiving a selection for one or more options in accordance with the presented options; post-processing the captured panoramic video content in accordance with the received selection; and causing display of the post-processed captured panoramic video content.

In one variant, the method further includes performing facial recognition for one or more entities in the captured panoramic video content; detecting speech in the captured panoramic content; and determining an entity of the one or more entities by associating the detecting with the performing of the facial recognition.

In another variant, the method further includes zooming in on the determined entity during moments of the detecting of speech associated with the determined entity.

In yet another variant, the analyzing of the captured panoramic video content includes analyzing metadata associated with the captured panoramic content

In yet another variant, the method further includes positioning a viewport so as to frame the determined entity; detecting speech in the captured panoramic content associated with a second entity of the one or more entities, the second entity differing from the entity; and altering the position of the viewport so as to frame the second entity rather than framing the determined entity.

In yet another variant, the analyzing of the captured panoramic video content for the portions that satisfy the cinematic criteria includes detecting a translation movement, the translation movement being indicative of movement of a foreground object with respect to a background object.

In yet another variant, the presenting of the options includes presenting a dolly pan option responsive to the detecting of the translation movement.

In yet another variant, the presenting of the options includes presenting an option to segment the foreground object from the background object and the post-processing of the captured panoramic content in response to receiving a selection for the segmentation includes blurring one of the foreground object or the background object.

In another embodiment, the method includes capturing panoramic video content; performing facial recognition for one or more entities in the captured content; detecting speech in the captured content; determining an entity for which speech is detected; presenting one or more options to a user of available cinematic styles; post-processing the captured content in accordance with the selected one or more options; and causing the display of the post-processed captured content.

In yet another embodiment, the method includes capturing panoramic video content; presenting one or more options for differing cinematic styles; receiving selections for the presented one or more options; analyzing the captured content for portions that satisfy the cinematic criteria; discarding portions that don't satisfy the cinematic criteria; post-processing the captured content in accordance with the selected one or more options; and causing the display of the post-processed captured content.

In another aspect, an image capture device is disclosed. In one embodiment, the image capture device is configured to capture panoramic content. In a variant, the image capture device is configured to perform one or more of the aforementioned methodologies.

In yet another aspect, a computing system is disclosed. In one embodiment, the computing system includes a processor apparatus; and a non-transitory computer readable apparatus that includes a storage medium having a computer program stored thereon, the computer program, which when executed by the processor apparatus, is configured to cause display of post-processed captured content via: presentation of options to a user of available cinematic styles for captured panoramic video content; receive a selection for one or more options in accordance with the presented options; analyze the captured panoramic video content for portions that satisfy a cinematic criteria in accordance with the received selection; post-process the captured panoramic video content in accordance with the received selection; and cause display of the post-processed captured panoramic video content.

In one variant, the computer program, which when executed by the processor apparatus, is further configured to: discard portions of the captured panoramic video content, which do not satisfy the cinematic criteria in accordance with the received selection.

In another variant, the presentation of the options to the user includes presentation of cinematic movie styles.

In yet another variant, the presentation of options is associated with determined metadata associated with the captured panoramic video content.

In yet another variant, the computer program, which when executed by the processor apparatus, is further configured to: store prior selections of the user for cinematic styles; and the presentation of the options is in accordance with the stored prior selections.

In yet another variant, the computer program, which when executed by the processor apparatus, is further configured to: receive cinematic input; and train the computer program in accordance with the received cinematic input in order to generate the available cinematic styles.

In yet another variant, the presentation of the options is in accordance with the generated available cinematic styles.

In yet another aspect, a system for panoramic content capture and viewing is disclosed. In one embodiment, the system includes an image capture device and the aforementioned computing system. The system is further configured to perform one or more of the aforementioned methodologies.

In yet another aspect, a computer-readable apparatus is disclosed. In one embodiment, the computer-readable apparatus includes a storage medium having instructions stored thereon, the instructions being configured to, when executed by a processor apparatus: analyze captured panoramic video content for portions that satisfy a cinematic criteria; present options to a user of available cinematic styles pursuant to the satisfied cinematic criteria; receive a selection for one or more options in accordance with the presented options; post-process the captured panoramic video content in accordance with the received selection; and cause display of the post-processed captured panoramic video content.

In one variant, the analysis of the captured panoramic video content includes determination of an object of interest; and the presentation of options includes an option to either: (1) pan ahead of the object of interest; or (2) pan behind the object of interest.

In another variant, the analysis of the captured panoramic video content includes determination of two or more faces within the captured panoramic video content; and the presentation of options includes an option to post-process the captured panoramic content in accordance with a perspective of one of the two or more faces.

In yet another variant, the computer program, which when executed by the processor apparatus, is further configured to: perform facial recognition on two or more individuals in the captured panoramic video content; detect speech in the captured panoramic content; and determine an individual of the two or more individuals associated with the detected speech.

In yet another variant, the presentation of options includes an option to frame the determined individual within a post-processed viewport within a portion of the captured panoramic video content.

In yet another variant, the computer program, which when executed by the processor apparatus, is further configured to: present an option to zoom in on the determined individual contemporaneous with moments of detected speech associated with the individual.

In yet another variant, the computer program, which when executed by the processor apparatus, is further configured to: position a viewport so as to frame the determined individual; detect speech in the captured panoramic content associated with a second individual of the two or more individuals, the second individual differing from the first individual; and alter the position of the viewport so as to frame the second individual rather than the first individual.

In yet another aspect, an integrated circuit apparatus is disclosed. In one embodiment, the integrated circuit apparatus is configured to: analyze captured content for portions that satisfy a cinematic criterion; present one or more options to a user of available cinematic styles; post-process the captured content in accordance with the selected one or more options; and cause the display of the post-processed captured content.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a functional block diagram illustrating a system for panoramic content capture and viewing in accordance with one implementation.

FIG. 2 is a logical flow diagram illustrating one exemplary implementation of a method for causing the display of post-processed captured content, such as content captured using the system of FIG. 1, in accordance with the principles of the present disclosure.

FIG. 3 is a logical flow diagram illustrating another exemplary implementation of a method for causing the display of post-processed captured content, such as content captured using the system of FIG. 1, in accordance with the principles of the present disclosure.

FIG. 4 is a logical flow diagram illustrating yet another exemplary implementation of a method for causing the display of post-processed captured content, such as content captured using the system of FIG. 1, in accordance with the principles of the present disclosure.

FIG. 5 is a block diagram of an exemplary implementation of a computing device, useful in performing, for example, the methodologies of FIGS. 2-4, in accordance with the principles of the present disclosure.

All Figures disclosed herein are © Copyright 2017-2018 GoPro Inc. All rights reserved.

### DETAILED DESCRIPTION

Implementations of the present technology will now be described in detail with reference to the drawings, which are provided as illustrative examples and species of broader genus' so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

### Wider FOV (Panoramic) Image Capture Device

Panoramic content (e.g., content captured using 180 degree, 360-degree view field, and/or other wider fields of view) and/or virtual reality (VR) content, may be characterized by high image resolution (e.g., 8192×4096 pixels at 90 frames per second (also called 8K resolution)) and/or high bit rates (e.g., up to 100 megabits per second (mbps)). Imaging content characterized by full circle coverage (e.g., 180°×360° or 360°×360° field of view) may be referred to as spherical content. Panoramic and/or virtual reality content may be viewed by a client device using a “viewport” into the extent of the panoramic image. As used herein, the term “viewport” refers generally to an actively displayed region of larger imaging content that is being displayed, rendered, or otherwise made available for presentation. For example, and as previously alluded to, a panoramic image or other wide FOV content is larger and/or has different dimensions than the screen capabilities of a display device. Accordingly, a user may select only a portion of the content for display (i.e., the viewport) by for example, zooming in/out on a spatial position within the content. In another example, a 2D viewpoint may be rendered and displayed dynamically based on a computer model of a virtualized 3D environment, so as to enable virtual reality, augmented reality, or other hybridized reality environments.

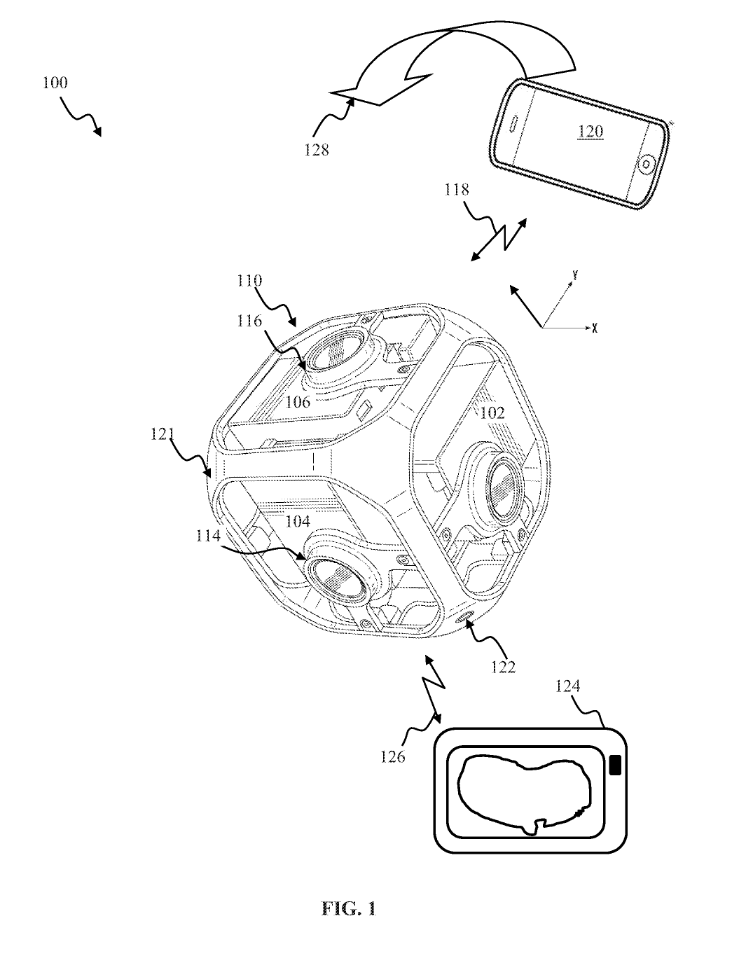

FIG. 1 illustrates a capture system 100 configured for acquiring panoramic content, in accordance with one implementation. The system 100 of FIG. 1 may include a capture apparatus 110, such as an action camera manufactured by the Assignee hereof (e.g., a GoPro device or the like, such as a HERO6 Black, HERO5 Session, or Fusion image/video capture devices), and/or other image/video capture devices.

The capture apparatus 110 may include, for example, 6-cameras (including, e.g., cameras 104, 106, 102 with the other 3-cameras hidden from view) disposed in a cube-shaped cage 121. The cage 121 may be outfitted with a mounting port 122 configured to enable attachment of the camera to a supporting structure (e.g., tripod, photo stick). The cage 121 may provide a rigid support structure. Use of a rigid structure may, inter alia, ensure that orientation of individual cameras with respect to one another may remain at a given configuration during operation of the apparatus 110. Individual capture devices (e.g., camera 102) may include a video camera device, such as that described in, for example, U.S. patent application Ser. No. 14/920,427 entitled “APPARATUS AND METHODS FOR EMBEDDING METADATA INTO VIDEO STREAM” filed on Oct. 22, 2015, now U.S. Pat. No. 9,681,111, the foregoing being incorporated herein by reference in its entirety.

In some implementations, the capture device may include two (2) spherical (e.g., “fish eye”) cameras that are mounted in a back-to-back configuration (also commonly referred to as a “Janus” configuration). For example, the GoPro Fusion image capture device manufactured by the Assignee hereof, is one such example of a capture device with its cameras mounted in a back-to-back configuration. As used herein, the term “camera” includes, without limitation, sensors capable of receiving electromagnetic radiation, whether in the visible band or otherwise (e.g., IR, UV), and producing image or other data relating thereto. The two (2) source images in a Janus configuration have a 180° or greater field of view (FOV); the resulting images may be stitched along a boundary between the two source images to obtain a panoramic image with a 360° FOV. The “boundary” in this case refers to the overlapping image data from the two (2) cameras. Stitching may be necessary to reconcile differences between pixels of the source images introduced based on for example, lighting, focus, positioning, lens distortions, color, etc. Stitching may stretch, shrink, replace, average, and/or reconstruct imaging data as a function of the input images. Janus camera systems are described in, for example, U.S. Design patent application Ser. No. 29/548,661, entitled “MULTI-LENS CAMERA” filed on Dec. 15, 2015, and U.S. patent application Ser. No. 15/057,896, entitled “UNIBODY DUAL-LENS MOUNT FOR A SPHERICAL CAMERA” filed on Mar. 1, 2016, which is incorporated herein by reference in its entirety. In some implementations, the natively captured panoramic content may be re-projected into a format associated with, for example, single vantage point cameras such as that described in co-owned U.S. Provisional Patent Application Ser. No. 62/612,041 filed Dec. 29, 2017 and entitled “Methods and Apparatus for Re-Projection of Panoramic Content”, the contents of which being incorporated herein by reference in its entirety.

Referring back to FIG. 1, the capture apparatus 110 may be configured to obtain imaging content (e.g., images and/or video) with a 360° FOV, also referred to as panoramic or spherical content, such as, for example, those shown and described in U.S. patent application Ser. No. 14/949,786, entitled “APPARATUS AND METHODS FOR IMAGE ALIGNMENT” filed on Nov. 23, 2015, now U.S. Pat. No. 9,792,709, and/or U.S. patent application Ser. No. 14/927,343, entitled “APPARATUS AND METHODS FOR ROLLING SHUTTER COMPENSATION FOR MULTI-CAMERA SYSTEMS”, filed Oct. 29, 2015, each of the foregoing being incorporated herein by reference in its entirety. As described in the above-referenced applications, image orientation and/or pixel location may be obtained using camera motion sensor(s). Pixel location may be adjusted using camera motion information in order to correct for rolling shutter artifacts. As described in the above-referenced U.S. patent application Ser. No. 14/949,786, images may be aligned in order to produce a seamless stitch in order to obtain the composite frame source. Source images may be characterized by a region of overlap. A disparity measure may be determined for pixels along a border region between the source images. A warp transformation may be determined using an optimizing process configured to determine displacement of pixels of the border region based on the disparity. Pixel displacement at a given location may be constrained in a direction that is tangential to an epipolar line corresponding to the location. A warp transformation may be propagated to pixels of the image. Spatial and/or temporal smoothing may be applied. In order to obtain an optimized solution, the warp transformation may be determined at multiple spatial scales

In one exemplary embodiment, the individual cameras (e.g., cameras 102, 104, 106) may be characterized by a FOV, such as 120° in longitudinal dimension and 60° in latitudinal dimension. In order to provide for an increased overlap between images obtained with adjacent cameras, the image sensors of any two adjacent cameras may be configured to overlap a field of view of 60° with respect to one another. By way of a non-limiting illustration, the longitudinal dimension of a camera 102 sensor may be oriented at 60° with respect to the longitudinal dimension of the camera 104 sensor; the longitudinal dimension of camera 106 sensor may be oriented at 60° with respect to the longitudinal dimension of the camera 104 sensor. In this manner, the camera sensor configuration illustrated in FIG. 1, may provide for 420° angular coverage in the vertical and/or horizontal planes. Overlap between multiple fields of view of adjacent cameras may provide for an improved alignment and/or stitching of multiple source images to produce, for example, a panoramic image, particularly when source images may be obtained with a moving capture device (e.g., rotating camera).

Individual cameras of the apparatus 110 may include a lens, for example, lens 114 of the camera 104, lens 116 of the camera 106. In some implementations, the individual lens may be characterized by what is referred to as a fisheye pattern and produce images characterized by a fish eye (or near-fish eye) FOV. Images captured by two or more individual cameras of the apparatus 110 may be combined using “stitching” of fisheye projections of captured images to produce an equirectangular planar image, in some implementations, such as shown in U.S. patent application Ser. No. 14/949,786, incorporated supra. In some embodiments, wide-angle images captured by two or more cameras may be directly stitched in some other projection, for example, cubic or octahedron projection.

The capture apparatus 110 may house one or more internal metadata sources, for example, video, inertial measurement unit(s) or accelerometer(s), gyroscopes (e.g., for assisting in determination of attitude of the capture apparatus 110), global positioning system (GPS) receiver component(s) and/or other metadata source(s). In some implementations, the capture apparatus 110 may include a device described in detail in U.S. patent application Ser. No. 14/920,427, entitled “APPARATUS AND METHODS FOR EMBEDDING METADATA INTO VIDEO STREAM” filed on Oct. 22, 2015, incorporated supra. The capture apparatus 110 may include one or more optical elements, for example, the camera lenses 114 and 116. Individual optical elements may include, by way of non-limiting examples, one or more of standard lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, polarized lens, other lens, and/or other optical elements.

The capture apparatus 110 may include one or more image sensors including, by way of non-limiting examples, one or more of charge-coupled device (CCD) sensor(s), active pixel sensor(s) (APS), complementary metal-oxide semiconductor (CMOS) sensor(s), N-type metal-oxide-semiconductor (NMOS) sensor(s), and/or other image sensor(s). The capture apparatus 110 may include one or more microphones configured to provide audio information that may be associated with images being acquired by the image sensor (e.g., audio obtained contemporaneously with the captured images).

The capture apparatus 110 may be interfaced to an external metadata source 124 (e.g., GPS receiver, cycling computer, metadata puck, and/or other device configured to provide information related to system 100 and/or its environment) via a remote link 126. The capture apparatus 110 may interface to an external user interface device 120 via the link 118. In some implementations, the device 120 may correspond to a smartphone, a tablet computer, a phablet, a smart watch, a portable computer, and/or other device configured to receive user input and communicate information with the camera capture device 110. In some implementations, the capture apparatus 110 may be configured to provide panoramic content (or portions thereof) to the device 120 for viewing.

In one or more implementations, individual links 126, 118 may utilize any practical wireless interface configuration, for example, Wi-Fi, Bluetooth (BT), cellular data link, ZigBee, Near Field Communications (NFC) link, for example, using ISO/IEC 14443 protocol, IEEE Std. 802.15, 6LowPAN, Z-Wave, ANT+ link, and/or other wireless communications link. In some implementations, individual links 126, 118 may be effectuated using a wired interface, for example, HDMI, USB, digital video interface, DisplayPort interface (e.g., digital display interface developed by the Video Electronics Standards Association (VESA), Ethernet, Thunderbolt), and/or other interface.

In some implementations (not shown), one or more external metadata devices may interface to the apparatus 110 via a wired link, for example, HDMI, USB, coaxial audio, and/or other interface. In one or more implementations, the capture apparatus 110 may house one or more sensors (e.g., GPS, pressure, temperature, accelerometer, heart rate, and/or other sensors). The metadata obtained by the capture apparatus 110 may be incorporated into the combined multimedia stream using any applicable methodologies including those described in U.S. patent application Ser. No. 14/920,427 entitled “APPARATUS AND METHODS FOR EMBEDDING METADATA INTO VIDEO STREAM” filed on Oct. 22, 2015, incorporated supra.

The user interface device 120 may operate a software application (e.g., Quik Desktop, GoPro App, Fusion Studio and/or other application(s)) configured to perform a variety of operations related to camera configuration, control of video acquisition, and/or display of video captured by the camera apparatus 110. An application (e.g., GoPro App) may enable a user to create short video clips and share clips to a cloud service (e.g., Instagram, Facebook, YouTube, Dropbox); perform full remote control of camera 110 functions; live preview video being captured for shot framing; mark key moments while recording with HiLight Tag; View HiLight Tags in GoPro Camera Roll for location and/or playback of video highlights; wirelessly control camera software; and/or perform other functions. Various methodologies may be utilized for configuring the camera apparatus 110 and/or displaying the captured information, including those described in U.S. Pat. No. 8,606,073, entitled “BROADCAST MANAGEMENT SYSTEM”, issued Dec. 10, 2013, the foregoing being incorporated herein by reference in its entirety.

By way of an illustration, the device 120 may receive user setting characterizing image resolution (e.g., 3840 pixels by 2160 pixels), frame rate (e.g., 60 frames per second (fps)), and/or other settings (e.g., location) related to the relevant context, such as an activity (e.g., mountain biking) being captured. The user interface device 120 may communicate the settings to the camera apparatus 110.

A user may utilize the device 120 to view content acquired by the capture apparatus 110. The display on the device 120 may act as a viewport into the 3D space of the panoramic content that is captured. In some implementations, the user interface device 120 may communicate additional information (metadata) to the camera apparatus 110. By way of an illustration, the device 120 may provide orientation of the device 120 with respect to a given coordinate system, to the apparatus 110 to enable determination of a viewport location and/or dimensions for viewing of a portion of the panoramic content. For example, a user may rotate (sweep) the device 120 through an arc in space (as illustrated by arrow 128 in FIG. 1). The device 120 may communicate display orientation information to the capture apparatus 110. The capture apparatus 110 may provide an encoded bitstream configured to enable viewing of a portion of the panoramic content corresponding to a portion of the environment of the display location as it traverses the path 128.

The capture apparatus 110 may include a display configured to provide information related to camera operation mode (e.g., image resolution, frame rate, capture mode (sensor, video, photo)), connection status (connected, wireless, wired connection), power mode (e.g., standby, sensor mode, video mode), information related to metadata sources (e.g., heart rate, GPS), and/or other information. The capture apparatus 110 may include a user interface component (e.g., one or more buttons) configured to enable user to start, stop, pause, resume sensor and/or content capture. User commands may be encoded using a variety of approaches including but not limited to duration of button press (pulse width modulation), number of button presses (pulse code modulation), and/or a combination thereof. By way of an illustration, two short button presses may initiate sensor metadata and/or video capture mode described in detail elsewhere; a single short button press may be used to (i) communicate initiation of video and/or photo capture and cessation of video and/or photo capture (toggle mode), or (ii) video and/or photo capture for a given time duration or number of frames (burst capture). It will be recognized by those skilled in the art that various user command communication implementations may be realized using, for example, short/long button presses and the like. In some implementations, the capture apparatus 110 may implement an orientation-based user interface such as that described in, for example, co-owned U.S. patent application Ser. No. 15/945,596 filed Apr. 4, 2018 and entitled “Methods and Apparatus for Implementation of an Orientation-Based User Interface”, the contents of which being incorporated herein by reference in its entirety. Such orientation-based user interfaces may be particularly useful where space is limited and/or where more traditional user interfaces are not desirable.

### Storytelling Methodologies

As previously alluded to, the editing of wider FOV (e.g., 360°) content can be incredibly tedious to the average user due in large part to the volume of data captured as well as the near limitless number of ways this captured wider FOV content can be post-processed. In other words, since most display devices are only able to display a subset of the captured wider FOV content (e.g., a viewport); selecting an “ideal” or “interesting” viewport can be very time consuming, particularly for video applications. The Assignee of the present disclosure's branding is based in large part on a cinematographic mise-en-scène that is generated by teams of artists and photographers that curate a video sequence that is often times utilized for the purpose of, inter alia, product advertisement. However, it may not necessarily be obvious why consumers of the Assignee's products cannot emulate the production value associated with the Assignee's marketing content. As the average consumer does not have the cinematographic training to know when their capture is “interesting”, nor can they recreate the cinematographic “language”, the present disclosure provides for methodologies that enable the editing of this wider FOV content during post-processing that greatly enhances the value to a user for that user's captured content (and for that user's wider FOV image capture device, generally).

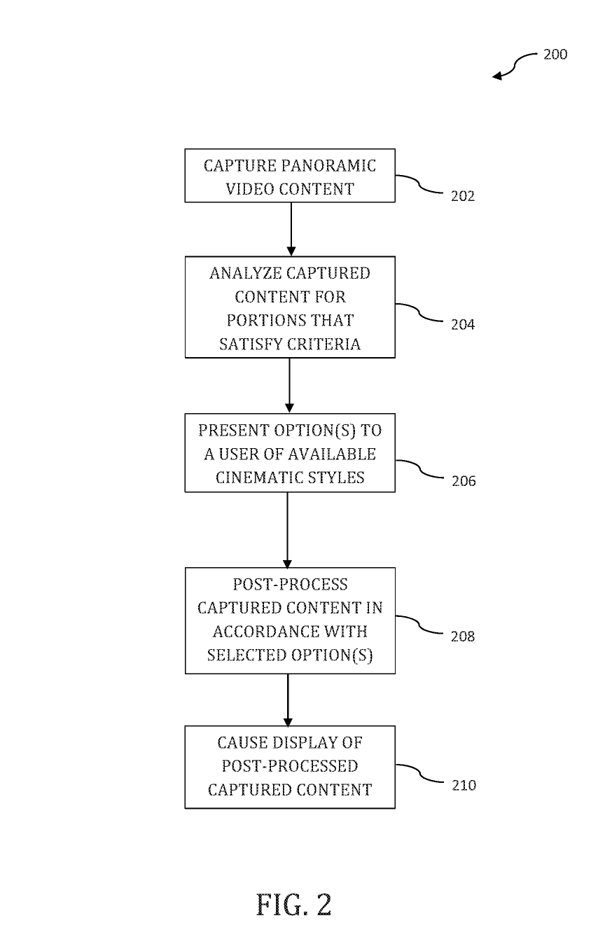

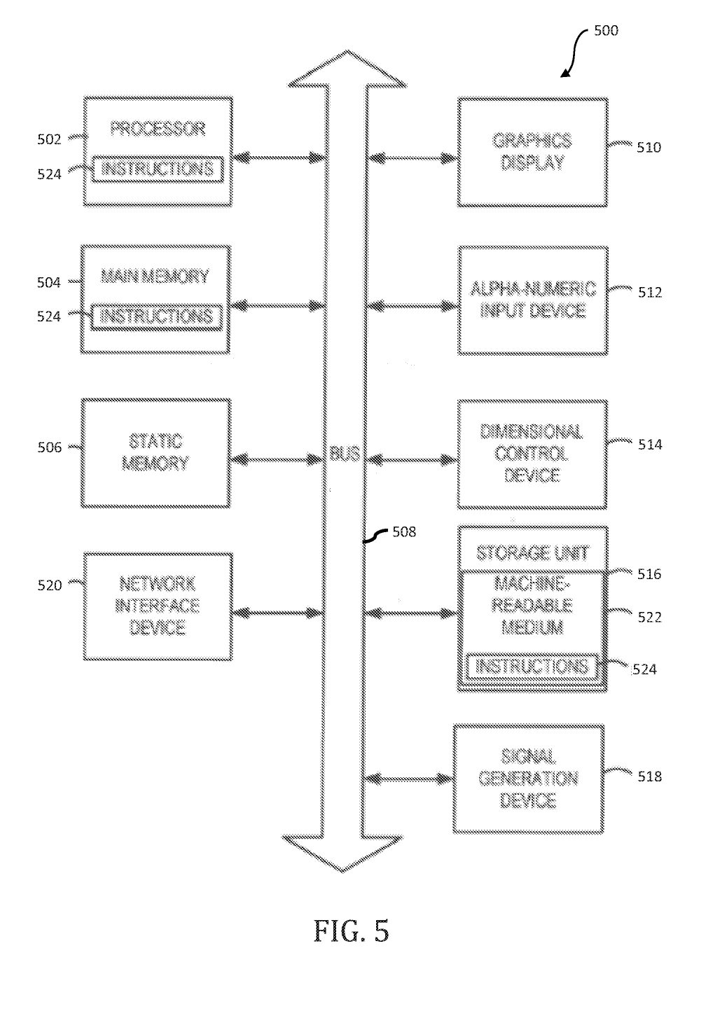

FIG. 2 illustrates one such methodology 200 for the processing and display of captured wider FOV content. At operation 202, panoramic video content is captured and/or transmitted/received. In some implementations, the panoramic video content may be captured using the capture apparatus 110 illustrated in FIG. 1. The captured content would be collectively characterized by the FOV of individual ones of the six cameras contained thereon that are to be later stitched in order to produce, for example, a 360° panoramic. In some implementations, panoramic video content is captured using an image capture device with two cameras such as, for example, the Fusion image capture device manufactured by the Assignee hereof. In yet other variants, the panoramic video content may be captured by two or more image capture devices, with the collective captured content from these two or more image capture devices being input into, for example, a computing system, such as computing system 500 described with respect to FIG. 5. These and other variants would be readily apparent to one of ordinary skill given the contents of the present disclosure.

At operation 204, the captured content is analyzed for portions that satisfy certain cinematic criteria. For example, the captured content may be analyzed for portions of content captured in low light conditions. The captured content may also be analyzed for portions of the content captured in brighter conditions (e.g., full bright daylight). In yet other variants, the captured content may be analyzed for portions of the content captured in areas lying between the aforementioned low light conditions and brighter conditions. In some implementations, the captured content may be analyzed for object movement as compared with, for example, the background scene, or for object recognition. Facial recognition algorithms may also be applied in order to not only determine the presence of a human, but also in order to determine the identity of a given human from, for example, frame to frame or portion to portion in the captured content. Other criteria of the captured content may be analyzed as well, including a determination of captured content that has high contrast, or that content which has centrally focused scenes, are rectilinear, have a limited color palette, and/or satisfy other pre-determined (e.g., patterned) cinematic criteria.

In some implementations, the analysis of the captured content may be performed by analyzing captured content metadata. For example, this analysis may be performed at the time of content capture. Herein lies one salient advantage of the present disclosure, in some implementations. Namely, as the analysis of the captured content may only occur with respect to the captured content metadata, analysis of the captured content metadata can be far less bandwidth intensive, and less computationally expensive, as compared with analysis of the captured imaging content itself. Examples of generated metadata may include the aforementioned lighting conditions at the time of capture, object movement, object recognition, facial recognition, high contrast captured content, color palette metadata, direction metadata, and literally any other type of useful metadata. In some implementations, various types of metadata may be tightly coupled with one another. For example, the direction metadata may be associated with an identified object (e.g., object recognition), or an identified face (e.g., facial recognition). Accordingly, in such an implementation, the direction metadata may include spatial and temporal coordinates associated with the identified object or the identified face within the captured content. For example, the metadata may include an identified object and/or an identified face (e.g., a person named Frank). Accordingly, the generated metadata may not only identify the individual of interest (i.e., Frank), but may further include spatial and temporal coordinates when the individual Frank has been captured by the image capture device. Additionally, direction metadata may include the motion of the camera itself. This camera motion direction metadata may be generated using, for example, GPS sensor data from the image capture device itself (e.g., for spatial/temporal positioning), one or more on-board accelerometers, one or more gyroscope sensors (e.g., for determination of camera attitude), and/or other sensor data for generating camera motion direction metadata. This camera motion direction metadata may be utilized for generating, for example, pan ahead and/or pan behind type shots. In other words, this camera motion direction metadata may be utilized for cinematic shot selection. These and other variations would be readily apparent to one of ordinary skill given the contents of the present disclosure.

At operation 206, one or more options are presented to a user of available cinematic styles. For example, a captured scene where a translation movement has been detected during operation 204 (e.g., through the use of directional metadata), may present the user with options such as whether to edit a portion of the captured content into a so-called dolly pan (i.e., motion that is orthogonal to the direction of movement for the image capture device). In some implementations, an option may be provided to a user for a so-called dolly zoom (i.e., motion that is inline to the direction of movement for the image capture device) which may move towards (or away) from an object of interest. For example, in some implementations, when approaching an object of interest (e.g., a human), the angle of view may be adjusted while the image capture device moves towards (or away) from the object of interest in such a way so as to keep the object of interest the same size throughout, resulting in a continuous perspective distortion. Such dolly zoom approaches have been used in numerous films such as, for example, Vertigo, Jaws, and Goodfellas. Additionally, at operation 206 an operation may be presented in order to dolly pan and/or dolly zoom to a particular identified object of interest (e.g., a pre-(or post-) identified individual or other pre-(or post-) designated object of interest).

For portions of the captured content that may have been captured in low light conditions (e.g., as indicated by generated metadata), various options may be presented to a user as well. For example, consider content captured around a dinner table in a darkened room. The content may be captured using a stationary image capture device. An individual sitting at the dinner table gets up and proceeds to walk around the dinner table in order to, for example, greet a newly arriving guest. In such a scenario, a user may be presented with an option to virtually “pan” the viewport in order to follow the individual as the individual walks around the dinner table. Due to the nature of the low light conditions within the room, and the fact that this panning effect is created through a virtualized camera lens (i.e., though the movement of the viewport location within the captured panoramic content at operation 202), the individual may appear blurry while the background may appear sharp, dependent upon conditions such as the speed at which the individual is moving and the lighting conditions for the room. Accordingly, a user may be presented with an option to perform a so-called whip pan towards, for example, the newly arriving guest as opposed to a pan in which the individual remains in the center of the viewport. As is well known in the film making arts, a whip pan is a type of pan shot in which a camera pans so quickly that the picture blurs into indistinct streaks. Accordingly, the fact that the individual may appear blurred due to the motion of the individual in these low light conditions, the use of a whip pan may allow for a more natural (visually appealing) cinematic appearance.

Conversely, in situations in which the captured content may have been captured under brighter conditions (e.g., full bright daylight as indicated by, for example, generated metadata); various options may be presented to a user as well. In such a scenario, it may be undesirable to pan the virtual camera as both the object of interest and the background may appear to be unnaturally focused (or sharp) during this pan. Accordingly, an option to not implement a pan may be presented to a user dependent upon, for example, a disparity between the motion of the object of interest and the background scene. For example, panning on a racecar as it travels around a track may look unnatural due to the relative speed of the racecar as compared with the background. Conversely, an option to perform object segmentation during a pan may be presented to a user. The use of object segmentation is described in, for example, co-owned U.S. patent application Ser. No. 15/270,971 filed Sep. 20, 2016 and entitled “Apparatus and Methods for Video Image Post-Processing for Segmentation-Based Interpolation”, the contents of which are incorporated herein by reference in its entirety. In such a usage scenario, the object of interest may be segmented from the background scene. The background scene may then have a blurring technique applied to it, while the object of interest remains in focus. Accordingly, this object segmentation technique during pans under brighter conditions may present a more natural feel to the post-processed content resulting in a more natural (visually appealing) cinematic appearance.

In some implementations, a user may be presented with an option to pan ahead of an object of interest. For example, given a stationary image capture device with an individual walking in front of the stationary image capture device, it may be desirable to pan the viewport such that a viewer of the post-processed content gets an opportunity to see where it is that the individual is going. Conversely, an option to pan away from an object of interest, or pan in a way that you cannot see where that individual is going may be utilized to create, for example, a more suspenseful feel to the post-processed video content, much as in the same way, many scenes in horror films or suspense thrillers are filmed. Variants in which multiple distinct image capture devices are utilized may be used to create more complex and aesthetically pleasing pans and cuts. These and other variants would be readily apparent to one of ordinary skill given the contents of the present disclosure.

In some implementations, it may be desirable to offer specific options that mimic the cinematographic styles of certain directors. For example, in mimicking the style of a director like David Fincher, a scene in which multiple individuals are talking with one another may be post-processed to include “shaky” or more erratic style framing of the shot when focused on one or more of the individuals, while providing a more stable shot when focused on other one(s) of the individuals. Such cinematographic renderings may recreate scenes such as the final scene in the movie Seven, where a more stable shot may be utilized to create the impression of control by the individual of interest in the stable shot, and creating an impression of a lack of control for the individual(s) in the shaky erratic shots. Another characteristic of directors like David Fincher may be to include precise virtual camera tilts, pans and/or tracking of an individual of interest as they move throughout the captured panoramic content. By mimicking these virtual camera movements so as to be precisely in tune with the movements of the individual of interest, the post-processed captured content gives the viewer a sense of being a part of the reality of the captured scene. These and other cinematographic styles may be readily understood and mimicked by one of ordinary skill given the contents of the present disclosure.

In some implementations, this presentation of options to a user of available cinematic styles may be done entirely with the aforementioned generated metadata. In other words, rather than having to transfer and/or analyze the entirety of the captured content, only the generated metadata will need to be analyzed and transferred. Such an ability to generate and create “interesting” cinematic stories in a way that takes fewer processing resources, is less bandwidth intensive, and involves less computation time. This may be particularly useful in the context of captured panoramic content due to the relatively large size of this captured panoramic content as well as the computationally expensive nature of stitching for this captured panoramic content. In the context of image stitching for panoramic capture, it may be possible to obviate the need to stitch for shots that are selected within the purview of a single image capture lens. Additionally, stitching computations may be performed only on captured content where the nature of the shot requires the use of two (or more) image capture lenses.

For example, video (and audio) scene analysis may require that all of the captured content be uncompressed. In many instances, the image capture device may inherently have to compress the captured content in order to, inter alia, reduce the data rate for transfer. However, the captured content will be uncompressed at the time of capture (i.e., will include the data from the sensors directly) and the generation of metadata may be performed prior to the captured content being compressed for storage. Accordingly, the presentation of option(s) to a user of available cinematic styles may be performed with significantly less data needing to be transferred off the image capture device. For example, the transfer of metadata for the presentation of options at operation 206 may be less than 0.1% of the size of the captured content itself. Accordingly, cinematic edit decisions can be generated and the needed segments are extracted from the captured video and audio in a manner that is much smaller in size and less computationally intensive than if the entirety of the captured content had to be transferred.

In some implementations, the presentation of option(s) to a user of available cinematic styles at operation 206 may be obviated altogether. In other words, the analysis of the captured content at operation 204, and the post-processing of the captured content at operation 208 as is described infra, may be performed without user input (contemporaneously or otherwise). For example, the post-processing software may determine “interestingness” of the captured content “out-of-the box” and may make editing decisions (e.g., through received metadata and/or captured content) without contemporaneous user input at the time of post-processing. In some implementations, these decision-less suggestions may be based on preset user preferences that may be, for example, content independent. For example, preset user preferences may include such items as always include faces in my post-processed content, or always give me faces for particular individuals (e.g., my children) in my post-processed content. Other examples may include setting a user preference for high acceleration moments, low acceleration moments, low-light conditions, bright-light conditions, or literally any other types of user preferences that may be tracked using the aforementioned different metadata types. Additionally, a user preference may include a particular song, album, artist, genre, etc. to include with my content. In some implementations, it may be desirable to make decision-less suggestions based on preset user preferences that are content dependent. In other words, dependent upon the type of content captured (e.g., capturing of content of an outdoor scene), preset user choices may be selected. Additionally, in some implementations, it may be desirable to modify a user's automated post-processing decisions over time through, for example, the implementation of machine learning algorithms. These and other variants would be readily apparent to one of ordinary skill given the contents of the present disclosure.

At operation 208, the captured panoramic video content may be post-processed in accordance with, for example, the selected option(s). For example, various one(s) of the aforementioned techniques may be selected such that the post-processed captured content may provide for a more “interesting” composition, thereby enabling a user of, for example, the aforementioned GoPro Fusion camera to create more visually interesting content, without necessitating that a user be necessarily aware of the techniques that underlie there creation, or necessarily require that all of the captured content be transferred. In a sense, unsophisticated or unknowledgeable users may be able to create visually interesting content purely by “overcapturing” a scene and editing this content in accordance with the presented cinematic styles presented at operation 206 and/or previously input user preferences and the like. In other words, since nearly limitless content/angles and the like are available for selection in a panoramic captured sequence (i.e., overcapturing), by presenting a user with available options for differing cinematic styles or sequences, or otherwise intelligently paring down in accordance with, for example, user preferences, a user can be essentially guided with options to provide more visually interesting edits. At operation 210, the post-processed captured content is displayed, or caused to be displayed, to the user who captured or edited the content, or to other users for which the user wishes to share this post-processed content with.

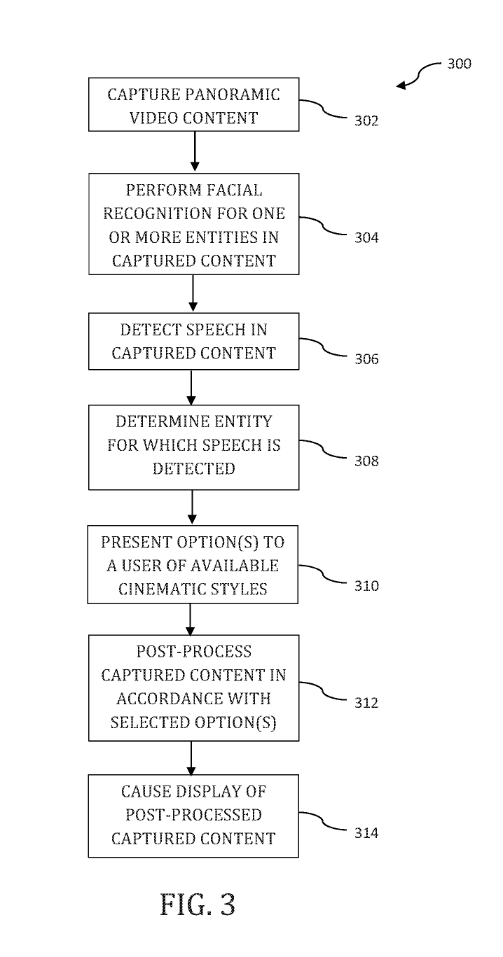

FIG. 3 illustrates another such methodology 300 for the processing and display of captured wider FOV content. At operation 302, panoramic video content is captured and/or transmitted/received. In some implementations, the panoramic video content may be captured using the capture apparatus 110 illustrated in FIG. 1. The captured content would be collectively characterized by the FOV of individual ones of the six cameras contained thereon that are to be later stitched in order to produce, for example, a 360° panoramic. In some implementations, panoramic video content is captured using an image capture device with two cameras such as, for example, the Fusion image capture device manufactured by the Assignee hereof. In yet other variants, the panoramic video content may be captured by two or more image capture devices, with the collective captured content from these two or more image capture devices being input into, for example, a computing system, such as computing system 500 described with respect to FIG. 5. In some implementations, only the metadata is transferred to the computing system 500 prior to the post-processing of this captured content at operation 312. These and other variants would be readily apparent to one of ordinary skill given the contents of the present disclosure.

At operation 304, facial recognition algorithms are performed for one or more entities in the captured content by using software in order to identify or verify an individual or individuals in the captured content. In some implementations, selected salient facial features (e.g., the relative position and/or size of the eyes, nose, cheekbones, and/or jaw) are then compared against a database having pre-stored facial characteristics stored therein. The recognition algorithms may include one or more of a principal component analysis using Eigen faces, linear discriminant analysis, elastic bunch graph matching using the Fisherface algorithm, hidden Markov models, multilinear subspace learning using tensor representation and/or the neuronal motivated dynamic link matching. In some variants, the software may only be used to determine the presence of a face without requiring a comparison against known faces in a database. In some implementations, the results (or portions thereof) of this facial recognition performance are stored in metadata.

At operation 306, speech is detected in the captured content. In some implementations, a microphone is utilized in order to detect speech. A visual determination may be used, additionally or alternatively, to the use of a microphone in order to recognize the visual cues associated with speech (i.e., an individual's mouth may be recognized as moving in a fashion that is characteristically associated with the act of speaking). A combination of detected speech via the use of a microphone along with the recognition of visual cues associated with speech may be utilized in order to determine the entity for which speech is detected at operation 308. In some implementations, the results from this analysis may be stored in metadata.

At operation 310, option(s) are presented to a user of available cinematic styles. For example, upon determination of the entity for which speech is detected, a user may select an option to position the viewport towards the user that is speaking. These options may be presented as a result of an analysis of metadata that may be forwarded to a user for selection. Options may also be presented for how the individual who is speaking should be framed (e.g., in the center of the viewport, to the left of center, to the right of center and/or any other options that may determine how the individual who is speaking should be framed). In some implementations, the viewport may “zoom” in slightly onto the individual who is speaking while they speak. Such a zooming in selection may make the display of the captured content more “interesting” as a user of the rendered content may be able to sub-consciously “engage” with the individual for which speech is detected. In other words, this zooming in effect draws the viewer into the conversation. Other options may be presented as well. For example, when two or more users are speaking with one another, a cut scene option may be presented. In other words, the viewport may cut from one individual to another individual as these individuals speak with one another.

In implementations where multiple cameras are utilized for the capturing of the panoramic video content, options may be presented for the selection of not only the aforementioned options, but may also further include a determination as to which image capture device should be selected. For example, a user may desire to alternate between various one of the cameras in order to share a perspective that is indicative of being from the perspective of the speaker, or from the perspective of one or more of the listeners. Such a technique was utilized in, for example, the scene between Hannibal Lecter and Clarice Starling in the film The Silence of the Lambs in order to cue the watcher of the film not only as to the content of the speech, but how to perceive the speech from the perspective of the characters in the captured scene. In some variants, the presenting of option(s) of available cinematic styles may be obviated altogether in accordance with the techniques described supra. These and other variations would be readily apparent to one of ordinary skill given the contents of the present disclosure.

At operation 312, the captured panoramic video content may be post-processed in accordance with, for example, the selected option(s). For example, various one(s) of the aforementioned techniques may be selected such that the post-processed captured content may provide for a more “interesting” composition, thereby enabling a user to create more visually interesting content without necessitating a user to necessarily be aware of the techniques that underlie there creation. At operation 314, the post-processed captured content is displayed, or caused to be displayed, to the user who captured or edited the content, or to other users for which the user wishes to share this post-processed content with.

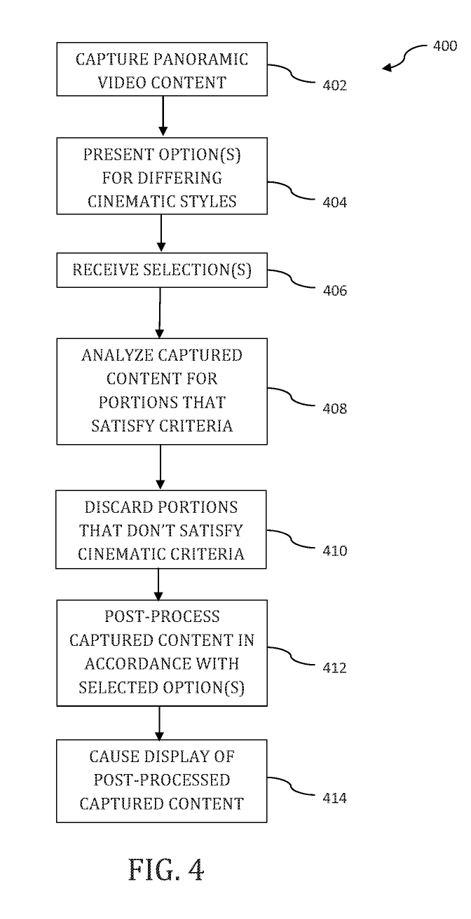

FIG. 4 illustrates another such methodology 400 for the processing and display of captured wider FOV content. At operation 402, panoramic video content is captured and may be transmitted/received and/or the captured metadata associated with the captured content may be transmitted/received. In some implementations, the panoramic video content may be captured using the capture apparatus 110 illustrated in FIG. 1. Additionally, the aforementioned metadata may be generated at the time of image capture. The captured content may be collectively characterized by the FOV of individual ones of the six cameras contained thereon that are to be later stitched in order to produce, for example, a 360° panoramic. In some implementations, panoramic video content is captured using an image capture device with two cameras such as, for example, the Fusion image capture device manufactured by the Assignee hereof. In yet other variants, the panoramic video content may be captured by two or more image capture devices, with the collective captured content from these two or more image capture devices being input into, for example, a computing system, such as computing system 500 described with respect to FIG. 5. These and other variants would be readily apparent to one of ordinary skill given the contents of the present disclosure.

At operation 404, differing cinematic style options may be presented to a user. For example, a user may be presented with an option to render their captured content in accordance with the styling of the film Godfather where, for example, scenes that have high contrast, mostly dark could be rendered in accordance with that cinematic style. A user may also be presented with an option to render their captured content in accordance with the styling of a Wes Anderson film (e.g., the selection of portions of the captured content that have centrally focused, rectilinear, limited color palette, and the like). Other variations may be offered as well that may be trainable to a particular cinematographic style (e.g., based on specific film inputs). These and other variants would be readily apparent to one of ordinary skill given the contents of the present disclosure. In some implementations, machine learning may be applied to adapt to a given user's previously chosen selections or preferences, or even to adapt to user preference selections given prior to content capture. For example, software may determine which selections a given user has preferred in the past and may only present options to that user in accordance with those learned preferences. In other words, such a variant enables the provision of options that are known to be preferable to that given user, thereby limiting the available number of options, thereby, for example, not overwhelming the user with numerous available options. In some implementations, a user may have the option of choosing between “learned” preferences and a more full listing of available cinematic options.

At operation 406, selections are received from a user and at operation 408, the captured content is analyzed for portions that satisfy the selected criteria. Notably, not every effect may be created given the captured content, but certain captures may allow for multiple options. At operation 410, portions of the captured content may be discarded that do not satisfy the cinematic criteria selected at operation 406. At operation 412, the captured panoramic video content may be post-processed in accordance with the selected option(s). For example, various one(s) of the aforementioned techniques may be selected such that the post-processed captured content may provide for a more “interesting” composition, thereby enabling a user to create more visually interesting content without necessitating a user to necessarily be aware of the techniques that underlie there creation. At operation 414, the post-processed captured content is displayed, or caused to be displayed, to the user who captured or edited the content, or to other users for which the user wishes to share this post-processed content with.

### Exemplary Apparatus

FIG. 5 is a block diagram illustrating components of an example computing system 500 able to read instructions from a computer-readable medium and execute them in one or more processors (or controllers). The computing system in FIG. 5 may represent an implementation of, for example, an image/video processing device for the purpose of implementing the methodologies of, for example, FIGS. 2-4.

The computing system 500 can be used to execute instructions 524 (e.g., program code or software) for causing the computing system 500 to perform any one or more of the rendering methodologies (or processes) described herein. In alternative embodiments, the computing system 500 operates as a standalone device or a connected (e.g., networked) device that connects to other computer systems. The computing system 500 may include, for example, an action camera (e.g., a camera capable of capturing, for example, a 360° FOV), a personal computer (PC), a tablet PC, a notebook computer, or other device capable of executing instructions 524 (sequential or otherwise) that specify actions to be taken. In another embodiment, the computing system 500 may include a server. In a networked deployment, the computing system 500 may operate in the capacity of a server or client in a server-client network environment, or as a peer device in a peer-to-peer (or distributed) network environment. Further, while only a single computer system 500 is illustrated, a plurality of computing systems 500 may operate to jointly execute instructions 524 to perform any one or more of the rendering methodologies discussed herein.

The example computing system 500 includes one or more processing units (generally processor apparatus 502). The processor apparatus 502 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of the foregoing. The computing system 500 may include a main memory 504. The computing system 500 may include a storage unit 516. The processor 502, memory 504 and the storage unit 516 may communicate via a bus 508.

In addition, the computing system 500 may include a static memory 506 and a display driver 510 (e.g., to drive a plasma display panel (PDP), a liquid crystal display (LCD), a projector, or other types of displays). The computing system 500 may also include input/output devices, for example, an alphanumeric input device 512 (e.g., touch screen-based keypad or an external input device such as a keyboard), a dimensional (e.g., 2-D or 3-D) control device 514 (e.g., a touch screen or external input device such as a mouse, a trackball, a joystick, a motion sensor, or other pointing instrument), a signal capture/generation device 518 (e.g., a speaker, camera, GPS sensor, accelerometers, gyroscopes and/or microphone), and a network interface device 520, which also are configured to communicate via the bus 508.

Embodiments of the computing system 500 corresponding to a client device may include a different configuration than an embodiment of the computing system 500 corresponding to a server. For example, an embodiment corresponding to a server may include a larger storage unit 516, more memory 504, and a faster processor 502 but may lack the display driver 510, input device 512, and dimensional control device 514. An embodiment corresponding to an action camera may include a smaller storage unit 516, less memory 504, and a power efficient (and slower) processor 502 and may include multiple image capture devices 518 (e.g., to capture 360° FOV images or video).

The storage unit 516 includes a computer-readable medium 522 on which is stored instructions 524 (e.g., a computer program or software) embodying any one or more of the methodologies or functions described herein. The instructions 524 may also reside, completely or at least partially, within the main memory 504 or within the processor 502 (e.g., within a processor's cache memory) during execution thereof by the computing system 500, the main memory 504 and the processor 502 also constituting computer-readable media. The instructions 524 may be transmitted or received over a network via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store the instructions 524. The term “computer-readable medium” shall also be taken to include any medium that is capable of storing instructions 524 for execution by the computing system 500 and that cause the computing system 500 to perform, for example, one or more of the methodologies disclosed herein.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that may be used to communicate date between two or more entities. The “bus” could be optical, wireless, infrared or another type of communication medium. The exact topology of the bus could be for example standard “bus”, hierarchical bus, network-on-chip, address-event-representation (AER) connection, or other type of communication topology used for accessing, for example, different memories in a system.

As used herein, the term “camera” may be used to refer to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

As used herein, the terms “computing device” or “computing system” includes, but is not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps that perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW110, and/or other variation.), USB (e.g., USB2), Ethernet (e.g., 10/100, 10/100/1000 (Gigabit Ethernet), 10-Gig-E, and/or other Ethernet implementations), MoCA, Coaxsys (e.g., TVnet™), radio frequency tuner (e.g., in-band or OOB, cable modem, and/or other protocol), Wi-Fi (802.11), WiMAX (802.16), PAN (e.g., 802.15), cellular (e.g., 3G, LTE/LTE-A/TD-LTE, GSM, and/or other cellular technology), IrDA families, and/or other network interfaces.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, and/or other wireless technology), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed is:

1. A method for causing display of post-processed captured content, the method comprising:
analyzing captured panoramic video content for portions that satisfy a cinematic criteria;
presenting options to a user of available cinematic styles pursuant to the satisfied cinematic criteria;
receiving a selection for one or more options in accordance with the presented options;
post-processing the captured panoramic video content in accordance with the received selection; and
causing display of the post-processed captured panoramic video content.

2. The method of claim 1, further comprising:
performing facial recognition for one or more entities in the captured panoramic video content;
detecting speech in the captured panoramic content; and
determining an entity of the one or more entities by associating the detecting with the performing of the facial recognition.

3. The method of claim 2, wherein the analyzing of the captured panoramic video content comprises analyzing metadata associated with the captured panoramic content.

4. The method of claim 2, further comprising:
positioning a viewport so as to frame the determined entity;
detecting speech in the captured panoramic content associated with a second entity of the one or more entities, the second entity differing from the entity; and
altering the position of the viewport so as to frame the second entity rather than framing the determined entity.

5. The method of claim 1, wherein the analyzing of the captured panoramic video content for the portions that satisfy the cinematic criteria comprises detecting a translation movement, the translation movement being indicative of movement of a foreground object with respect to a background object.

6. The method of claim 5, wherein the presenting of the options comprises presenting a dolly pan option responsive to the detecting of the translation movement.

7. The method of claim 5, wherein the presenting of the options comprises presenting an option to segment the foreground object from the background object and the post-processing of the captured panoramic content in response to receiving a selection for the segmentation comprises blurring one of the foreground object or the background object.

8. A non-transitory computer readable apparatus comprising a storage medium having a computer program stored thereon, the computer program, which when executed by a processor apparatus, is configured to cause display of post-processed captured content via:
analysis of captured panoramic video content for portions that satisfy a cinematic criteria;
present options to a user of available cinematic styles pursuant to the satisfied cinematic criteria;
receive a selection for one or more options in accordance with the presented options;
post-process the captured panoramic video content in accordance with the received selection; and
cause display of the post-processed captured panoramic video content.

9. The non-transitory computer readable apparatus of claim 8, wherein the analysis of the captured panoramic video content comprises determination of an object of interest via analysis of metadata associated with the captured panoramic video content; and
the presentation of options comprises an option to either: (1) pan ahead of the object of interest; or (2) pan behind the object of interest.

10. The non-transitory computer readable apparatus of claim 8, wherein the analysis of the captured panoramic video content comprises determination of two or more faces within the captured panoramic video content via analysis of metadata associated with the captured panoramic video content; and
the presentation of options comprises an option to post-process the captured panoramic content in accordance with a perspective of one of the two or more faces.

11. The non-transitory computer readable apparatus of claim 8, wherein the computer program, which when executed by the processor apparatus, is further configured to:
perform facial recognition on two or more individuals in the captured panoramic video content;
detect speech in the captured panoramic content; and
determine an individual of the two or more individuals associated with the detected speech.

12. The non-transitory computer readable apparatus of claim 11, wherein the presentation of options comprises an option to frame the determined individual within a post-processed viewport within a portion of the captured panoramic video content.

13. The non-transitory computer readable apparatus of claim 12, wherein the computer program, which when executed by the processor apparatus, is further configured to:
present an option to zoom in on the determined individual contemporaneous with moments of detected speech associated with the individual.

14. The non-transitory computer readable apparatus of claim 11, wherein the computer program, which when executed by the processor apparatus, is further configured to:
position a viewport so as to frame the determined individual;
detect speech in the captured panoramic content associated with a second individual of the two or more individuals, the second individual differing from the first individual; and
alter the position of the viewport so as to frame the second individual rather than the first individual.

15. A computing system, comprising:
a processor apparatus; and
a non-transitory computer readable apparatus comprising a storage medium having a computer program stored thereon, the computer program, which when executed by the processor apparatus, is configured to cause display of post-processed captured content via:
present options to a user of available cinematic styles for captured panoramic video content;
receive a selection for one or more options in accordance with the presented options;
analyze the captured panoramic video content for portions that satisfy a cinematic criteria in accordance with the received selection;
post-process the captured panoramic video content in accordance with the received selection; and
cause display of the post-processed captured panoramic video content.

16. The computing system of claim 15, wherein the computer program, which when executed by the processor apparatus, is further configured to:
discard portions of the captured panoramic video content which do not satisfy the cinematic criteria in accordance with the received selection.

17. The computing system of claim 15, wherein the presentation of the options to the user comprises presentation of cinematic movie styles.

18. The computing system of claim 15, wherein the computer program, which when executed by the processor apparatus, is further configured to:
store prior selections of the user for cinematic styles; and
the presentation of the options is in accordance with the stored prior selections.

19. The computing system of 15, wherein the computer program, which when executed by the processor apparatus, is further configured to:
receive cinematic input; and
train the computer program in accordance with the received cinematic input in order to generate the available cinematic styles.

20. The computing system of claim 19, wherein the presentation of the options is in accordance with the generated available cinematic styles.
